(19) United States
(12) Patent Application Publication
(10) Pub. No.: US 2026/0091360 A1
(43) Pub. Date: Apr. 2, 2026

(54) Gas Separation Membrane, Method For Manufacturing Gas Separation Membrane, And Gas Separation Apparatus

(71) Applicant: SEIKO EPSON CORPORATION, Tokyo (JP)

(72) Inventor: Masahiro FURUSAWA, Chino (JP)

(21) Appl. No.: 19/341,056

(22) Filed: Sep. 26, 2025

(30) Foreign Application Priority Data
Sep. 27, 2024 (JP) 2024-168451

(51) Int. Cl. B01D 71/02; B01D 67/00; B01D 69/12; B01D 71/06

(52) U.S. Cl. CPC B01D 71/022; B01D 67/0069; B01D 67/0095; B01D 69/12; B01D 71/06; B01D 2325/26

(57) ABSTRACT

Provided is a gas separation membrane separates a specific gas component from a mixed gas having a plurality of gas components by allowing the specific gas component to permeate therethrough, the gas separation membrane including:
a support layer formed of a porous body having pores;
a separation layer provided on one surface of the support layer and having a gas separation ability for the specific gas component; and
a blocking portion provided corresponding to a defective portion where the separation layer has a defect and the support layer is exposed, and containing metal.

### The present application is based on, and claims priority from JP Application Serial Number 2024-168451, filed Sep. 27, 2024, the disclosure of which is hereby incorporated by reference herein in its entirety.

### BACKGROUND

1. Technical Field

The present disclosure relates to a gas separation membrane, a method for manufacturing a gas separation membrane, and a gas separation apparatus.

### 2. Related Art

In order to realize carbon neutrality or carbon negativity, technologies are being considered to capture and recover carbon dioxide discharged from thermal power plants, boiler facilities, or the like, and carbon dioxide in the atmosphere. As that technique, there has been known a membrane separation method for separating carbon dioxide using a gas separation membrane.

The film thickness of gas separation membrane used in the membrane separation method is prepared to be thinner to allow more gas to permeate therethrough. However, it is very difficult to prepare a gas separation membrane having no defects.

In order to solve such a problem, JP-A-2003-290636 proposes, as a method for repairing a defect generated in a hydrogen separation membrane including a porous substrate and a membrane formed thereon, a defect repair method including a process of immersing the membrane surface in a liquid containing a binder component that solidifies upon drying and vacuum-suctioning the liquid from the porous substrate side to cause the solution to flow into the defective portion of the membrane and a process of solidifying the binder component in the solution that has flowed in by drying to seal the defective portion.

According to such a defect repair method, even when a defect exists in the membrane (which is a separation layer having gas separation ability), the porous substrate corresponding to the defective portion is made airtight, thereby blocking the passage of gas or the like through the defective portion. Accordingly, the defect can be easily repaired without substantially impairing the function of the membrane.

JP-A-2003-290636 is an example of the related art.

In the defect repair method described in JP-A-2003 -290636, it is necessary for a liquid containing a binder component to uniformly penetrate into a porous substrate. However, even when the binder component is solidified, a gap may remain. Therefore, it is not easy to make the porous substrate sufficiently airtight.

Therefore, it is an object to realize a gas separation membrane in which, even when the separation layer has a defect, the defective portion is blocked to realize airtightness, and which has a high gas selectivity ratio and a high gas permeability for a specific gas component.

### SUMMARY

A gas separation membrane according to an application example of the present disclosure is a separation membrane that separates a specific gas component from a mixed gas having a plurality of gas components by allowing the specific gas component to permeate therethrough, the gas separation membrane includes:
a support layer formed of a porous body having pores;
a separation layer provided on one surface of the support layer and having a gas separation ability for the specific gas component; and
a blocking portion provided corresponding to a defective portion where the separation layer has a defect and the support layer is exposed, and containing metal.

A method for manufacturing a gas separation membrane according to an application example of the present disclosure is a method for manufacturing the gas separation membrane according to the application example of the present disclosure, and includes:
preparing a multilayer film including the support layer formed of the porous body and the separation layer in which the defective portion is generated;
forming the blocking portion by a plating method, the blocking portion being selectively formed in the defective portion; and
drying the multilayer film in which the blocking portion is formed to obtain the gas separation membrane.

A gas separation apparatus according to an application example of the present disclosure includes:
the gas separation membrane according to the application example of the present disclosure;
a fixing portion that fixes the gas separation membrane and in which an internal space is formed at the support layer side of the gas separation membrane; and
an exhaust unit that reduces a pressure in the internal space so as to be negative with respect to an external space on the separation layer side of the gas separation membrane.

### BRIEF DESCRIPTION OF THE DRAWINGS

FIG. 1 is a cross-sectional view illustrating a gas separation membrane according to an embodiment.

FIG. 2 is a cross-sectional view of a gas separation membrane illustrating the problem to be solved by the present disclosure.

FIG. 3 is a cross-sectional view illustrating a gas separation membrane according to a modification in which a part of a blocking portion extends into the inside of a support layer.

FIG. 4 is a process diagram illustrating a configuration of a method for manufacturing the gas separation membrane according to the embodiment.

FIG. 5 is a schematic diagram illustrating the method for manufacturing the gas separation membrane illustrated in FIG. 4.

FIG. 6 is a schematic diagram illustrating the method for manufacturing the gas separation membrane illustrated in FIG. 4.

FIG. 7 is a schematic diagram illustrating the method for manufacturing the gas separation membrane illustrated in FIG. 4.

FIG. 8 is a schematic diagram illustrating the method for manufacturing the gas separation membrane illustrated in FIG. 4.

FIG. 9 is a schematic diagram illustrating the method for manufacturing the gas separation membrane illustrated in FIG. 4.

FIG. 10 is a schematic diagram illustrating the method for manufacturing the gas separation membrane illustrated in FIG. 4.

FIG. 11 is a schematic diagram illustrating the method for manufacturing the gas separation membrane illustrated in FIG. 4.

FIG. 12 is a cross-sectional view illustrating a schematic configuration of a gas separation apparatus according to an embodiment.

FIG. 13 is Table 1 showing configurations and evaluation results of the gas separation membranes of Examples 1 to 4 and the gas separation membranes in Comparative Examples 1 to 4.

FIG. 14 is Table 2 showing configurations and evaluation results of the gas separation membranes of Examples 5 to 8 and the gas separation membranes in Comparative Examples 5 to 8.

### DESCRIPTION OF EMBODIMENTS

Hereinafter, a gas separation membrane, a method for manufacturing a gas separation membrane, and a gas separation apparatus according to the present disclosure will be described in detail based on preferred embodiments shown in the accompanying drawings.

### 1. Overview of Gas Separation Membrane

First, a configuration of a gas separation membrane according to the embodiment will be outlined.

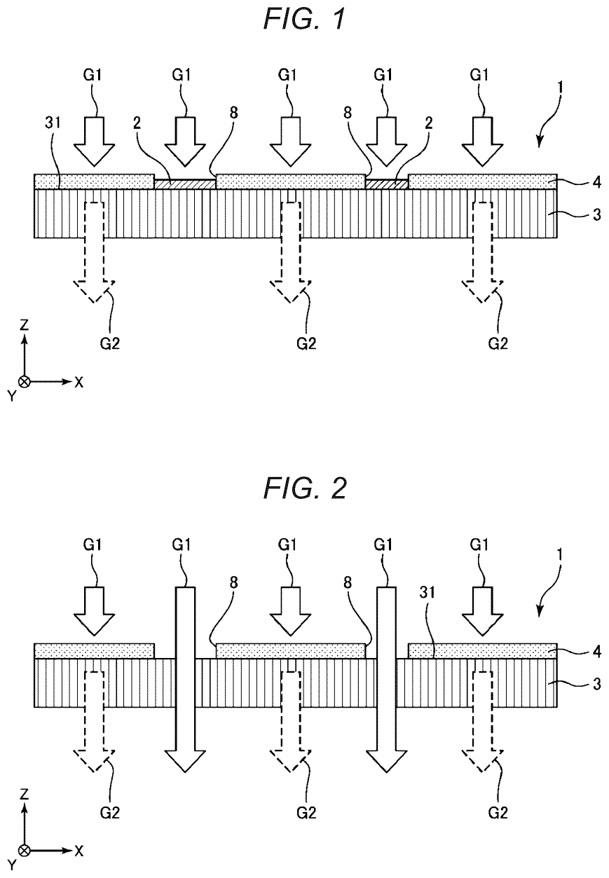

FIG. 1 is a cross-sectional view illustrating a gas separation membrane 1 according to an embodiment. FIG. 2 is a cross-sectional view of a gas separation membrane illustrating the problem to be solved by the present disclosure. In FIGS. 1 and 2 of the present application, an X axis, a Y axis, and a Z axis are set as three axes orthogonal to one another, and are indicated by arrows. A base end of the arrow indicating each axis is designated as “minus” and a tip end as “plus”.

In the gas separation membrane 1 illustrated in FIG. 1, a Z axis plus side is referred to as “upper”, and a Z axis minus side is referred to as “lower”. A mixed gas G1 having a plurality of gas components is supplied above gas separation membrane 1. In addition, in the gas separation membrane 1 of FIG. 1, a specific gas component preferentially permeates from an upper side to a lower side and is separated. As a result, in the gas (permeate gas G2) that has permeated through the gas separation membrane 1, the concentration of the specific gas component is higher than that in the mixed gas G1. Accordingly, the specific gas component can be separated and recovered from the mixed gas G1. In the following description, the upper side of the gas separation membrane 1 is also referred to as “upstream”, and the lower side of the gas separation membrane 1 is also referred to as “downstream”.

The gas separation membrane 1 illustrated in FIG. 1 includes a support layer 3 spreading along the X-Y plane, and a separation layer 4 provided on an upper surface 31 (one surface) of the support layer 3.

The support layer 3 includes a porous body having pores. The separation layer 4 has a gas separation ability of preferentially permeating and separating the specific gas component.

Here, when the gas separation membrane 1 is manufactured, the separation layer 4 is formed to cover the upper surface 31 of the support layer 3. In order for the separation layer 4 to sufficiently exhibit its gas separation ability, it is necessary to form the separation layer 4 that completely covers the upper surface 31. However, no matter how the manufacturing technique is enhanced, it is difficult to form the separation layer 4 that completely covers the upper surface 31, and a defective portion 8 such as a pinhole may be generated. When such a defective portion 8 is used as it is without being repaired, the gas separation ability for the separation layer 4 cannot be sufficiently utilized.

FIG. 2 illustrates flows of the mixed gas G1 and the permeate gas G2 when a gas separation membrane 9 including the support layer 3 and the separation layer 4 in which the defective portion 8 is generated is used without being repaired.

In the portion of the upper surface 31 of the support layer 3 covered with the separation layer 4, the permeate gas G2, which has a higher concentration of the specific gas component than the mixed gas G1, permeates through due to the gas separation ability for the separation layer 4. In the portion of the upper surface 31 of the support layer 3 not covered with the separation layer 4, that is, the defective portion 8, the gas separation ability does not work, and thus the mixed gas G1 permeates as it is. Therefore, unless the defective portion 8 is repaired, the concentration of the specific gas component cannot be sufficiently increased downstream of the separation membrane 9. That is to say, the gas selectivity ratio of the specific gas component in the gas separation membrane 9 cannot be sufficiently increased.

Therefore, the gas separation membrane 1 illustrated in FIG. 1 includes a blocking portion 2 that blocks the defective portion 8. The blocking portion 2 hermetically seals the defective portion 8 by covering the defective portion 8. Accordingly, the permeation of the mixed gas G1 through the defective portion 8 can be suppressed. As a result, the concentration of the specific gas component can be sufficiently increased downstream of the gas separation membrane 1. That is to say, it is possible to realize the gas separation membrane 1 having a sufficiently high gas selectivity ratio of the specific gas component.

In addition, since the blocking portion 2 contains metal, it has a high shielding rate against gas molecules even when it is thin. Therefore, it is possible to suppress a decrease in the gas selectivity ratio due to permeation of gas molecules through the blocking portion 2. In addition, since the blocking portion 2 is sufficiently thin, for example, even when there is a difference in thermal expansion coefficient between the blocking portion 2 and the support layer 3, the blocking portion 2 is less likely to peel off.

According to the above configuration, since the defective portion 8 such as a pinhole can be repaired by the blocking portion 2, the number of unrepaired defective portions 8 is zero or small, and the gas separation membrane 1 having a high gas selectivity ratio and a high gas permeability can be obtained.

Furthermore, the gas separation membrane according to the present disclosure may be in the form of a sheet (flat plate) as illustrated in FIG. 1, a spiral, a tubular shape, or a hollow fiber.

### 1.1. Support Layer

The support layer 3 illustrated in FIG. 1 has a sheet shape and supports the separation layer 4. Accordingly, it is possible to realize the gas separation membrane 1 in which damage or the like is unlikely to occur even when the separation layer 4 does not have sufficient mechanical characteristics.

The support layer 3 is formed of the porous body. The porous body is a sheet having a large number of pores and has good gas permeability. The porous body has rigidity higher than that of the separation layer 4, and is responsible for ensuring mechanical characteristics such as self-standing and durability of the gas separation membrane 1 as a whole.

Examples of the constituent material of the porous body include organic materials such as synthetic polymer materials and natural polymer materials, and inorganic materials such as ceramic materials, metal materials, and silicon materials. Among these, the porous body preferably contains the inorganic material, and more preferably contains the ceramic material. Since the inorganic material has high mechanical strength, the inorganic material contributes to thinning of the support layer 3 and to improvement in the gas permeability of the support layer 3. When the separation layer 4 is the organic material, the support layer 3 and the separation layer 4 can have different chemical properties. Accordingly, when the blocking portion 2 is formed in the defective portion 8, a process of selectively forming the blocking portion 2 in the defective portion 8 can be easily performed. The constituent material of the porous body may be a composite material of the organic material and the inorganic material.

Examples of the organic material include polyolefin resins such as polyethylene and polypropylene, fluorine-containing resins such as polytetrafluoroethylene, polyvinyl fluoride, and polyvinylidene fluoride, polystyrene, cellulose, cellulose acetate, polyurethane, polyacrylonitrile, polyphenylene oxide, polysulfone, polyethersulfone, polyimide, polyaramid, and nylon.

Examples of the ceramic material include alumina, cordierite, mullite, silicon carbide, and zirconia. Examples of the metal material include stainless steel. Examples of the silicon material include silicon single crystal and quartz glass.

The porous body may be a filter having an open cell structure. The filter having an open cell structure is also called an absolute-type filter, and includes the pores that are continuous from one surface to the other surface that are in a front-back relationship with each other and are independent from each other.

An average thickness of the support layer 3 is not particularly limited, and is preferably 1 μm or more and 3000 μm or less, more preferably 10 μm or more and 500 μm or less, and still more preferably 30 μm or more and 300 μm or less. Accordingly, the support layer 3 has the rigidity necessary and sufficient to support the separation layer 4, and can sufficiently ensure gas permeability, thereby enabling the separation layer 4 to exhibit a gas separation ability for the specific gas component.

When the average thickness of the support layer 3 is less than the lower limit value, the rigidity may be insufficient. However, when the average thickness of the support layer 3 exceeds the above upper limit value, the gas permeability of the support layer 3 decreases, and the gas separation ability for the separation layer 4 may not be sufficiently exhibited.

The average thickness of the support layer 3 is an average value of the thicknesses measured at 10 locations in the support layer 3. The thickness of the support layer 3 can be measured using, for example, a thickness gauge.

The porous body has a large number of pores, and an average inner diameter thereof is referred to as an “average pore diameter”. An average hole diameter of the porous body is preferably 0.1 nm or more and 1000 nm or less, more preferably 0.5 nm or more and 500 nm or less, still more preferably 1 nm or more and 300 nm or less, and particularly preferably 10 nm or more and 100 nm or less. Accordingly, the separation layer 4 can be prevented from slipping out downstream of the support layer 3 while sufficiently ensuring the gas permeability of the porous body. When the average pore diameter of the porous body falls below the lower limit value, the gas permeability of the porous body may decrease. Furthermore, when the average hole diameter of the porous body exceeds the upper limit value, the separation layer 4 may slip out downstream of the support layer 3.

The average hole diameter of the porous body can be measured by a through hole diameter evaluation device after the separation layer 4 is removed from the gas separation membrane 1 and the single support layer 3 is taken out. Examples of the through hole diameter evaluation device include a perm porometer manufactured by PMI.

A porosity of the porous body is preferably 20% or more and 90% or less, and more preferably 30% or more and 80% or less. Accordingly, the porous body can achieve both good gas permeability and sufficient rigidity.

The porosity of the porous body can be measured by the above-described through hole diameter evaluation device after the separation layer 4 is removed from the gas separation membrane 1.

The gas permeability of carbon dioxide in the support layer 3 is preferably 10×10⁻⁵ cm³ (STP)/cm²·sec·cmHg (100 GPU) or more, more preferably 1000 GPU or more, still more preferably 3000 GPU or more, and particularly preferably 10000 GPU or more.

### 1.2. Separation Layer

The separation layer 4 illustrated in FIG. 1 is provided on the upper surface 31 (one surface) of the support layer 3. The separation layer 4 has a gas separation ability for the specific gas component.

The separation layer 4 may be formed of an inorganic material, but is preferably formed of an organic material. Accordingly, the separation layer 4 corresponding to various gas components can be realized according to the composition of the organic material. In addition, by using the organic material, it is possible to realize the separation layer 4 having excellent coverage of the support layer 3 even when the layer thickness is thin. Such a separation layer 4 contributes to realization of the gas separation membrane 1 having a high gas selectivity ratio and a high gas permeability.

Examples of the organic material include polyolefin resins such as polyethylene and polypropylene, fluorine-containing resins such as polytetrafluoroethylene, polyvinyl fluoride, and polyvinylidene fluoride, polystyrene, cellulose, cellulose acetate, polyurethane, polyacrylonitrile, polyphenylene oxide, polysulfone, polyethersulfone, polyimide, polyaramid, organopolysiloxane, polyethylene terephthalate (PET), polyacetal (POM), and polylactic acid (PLA). The constituent material of the separation layer 4 may be a composite material of two or more of these materials.

Among these, an organopolysiloxane is preferably used as the constituent material of the separation layer 4. One molecule of the organopolysiloxane includes at least a unit (a T unit) represented by R¹SiO_{3/2}, a unit (a D unit) represented by R²R³SiO_{2/2}, and a unit (an M unit) represented by R⁴R⁵R⁶SiO_{1/2} as a basic constituent unit. In each unit, R¹ to R⁶ are an aliphatic hydrocarbon or a hydrogen atom. The organopolysiloxane is formed by combining the T unit, the D unit, and the M unit.

Specific examples of the organopolysiloxane include polydimethylsiloxane, polymethylphenylsiloxane, polydiphenylsiloxane, a polysulfone/polyhydroxystyrene/polydimethylsiloxane copolymer, a dimethylsiloxane/methylvinylsiloxane copolymer, a dimethylsiloxane/diphenylsiloxane/methylvinylsiloxane copolymer, a methyl-3,3,3-trifluoropropylsiloxane/methylvinylsiloxane copolymer, a dimethylsiloxane/methylphenylsiloxane/methylvinylsiloxane copolymer, vinyl terminated diphenylsiloxane/dimethylsiloxane copolymer, vinyl terminated polydimethylsiloxane, amino terminated polydimethylsiloxane, phenyl terminated polydimethylsiloxane, H terminated polydimethylsiloxane, and a dimethylsiloxane-methylhydrosiloxane copolymer. The expression “vinyl terminated” or the like indicates that at least one end of a principal chain contained in the organopolysiloxane is substituted with a substituent such as a vinyl group. This includes a form in which a crosslinking reactant is formed. The constituent material of the separation layer 4 may be one kind or a composite of two or more kinds thereof, or may be a composite material containing an organopolysiloxane as a main component in mass ratio and other resin components in combination.

The organopolysiloxane has a good affinity for carbon dioxide. Therefore, the separation layer 4 containing the organopolysiloxane exhibits a high gas selectivity ratio to carbon dioxide.

Any functional group may be introduced into an upstream surface of the separation layer 4 using a coupling agent or the like. By appropriately selecting the functional group, the affinity for the specific gas component can be further enhanced.

An average thickness of the separation layer 4 is not particularly limited, and is preferably 1 nm or more and 1000 nm or less, more preferably 3 nm or more and 800 nm or less, still more preferably 5 nm or more and 500 nm or less, and particularly preferably 10 nm or more and 200 nm or less. Accordingly, the separation layer 4 has good gas selectivity ratio and gas permeability. As a result, the gas separation membrane 1 that can reduce the input amount of energy required for separating the specific gas component, specifically, that can reduce a pressure difference between pressures upstream and downstream of the gas separation membrane 1 can be realized. When the average thickness of the separation layer 4 falls below the lower limit value, a probability of a large number of the defective portions 8 appearing in the separation layer 4 may increase, or the separation layer 4 may be easily broken afterwards. When the average thickness in the separation layer 4 exceeds the upper limit value, the gas permeability of the separation layer 4 may decrease, the input amount of energy required for separating may increase, and flexibility of the separation layer 4 may decrease.

The average thickness of the separation layer 4 is preferably 0.0050% or more and 1.0% or less, more preferably 0.010% or more and 0.50% or less, and still more preferably 0.030% or more and 0.30% or less, of the average thickness of the support layer 3. Accordingly, since a ratio of the thickness of the two layers can be optimized, the mechanical characteristics, the gas selectivity ratio, and the gas permeability of the gas separation membrane 1 can be satisfactorily balanced.

The average thickness of the separation layer 4 can be obtained, for example, by observing a cross section of the gas separation membrane 1 under magnification and calculating the average value of thicknesses measured at 10 locations. For the magnification observation, for example, a scanning electron microscope, a transmission electron microscope, or a scanning transmission electron microscope is used. Alternatively, the thickness of the separation layer 4 may be determined by depth profiling using X-ray photoelectron spectroscopy.

### 1.3. Blocking Portion

The blocking portion 2 illustrated in FIG. 1 contains metal and blocks the defective portion 8.

The metal contained in the blocking portion 2 is not particularly limited, and may be any metal, and examples thereof include Ni (nickel), Co (cobalt), Cu (copper), Au (gold), Pt (platinum), Pd (palladium), Ag (silver), Cr (chromium), Zn (zinc), Sn (tin), and In (indium). These metals may be contained as a single substance, or may be contained as an alloy, a compound, or a mixture with other elements. Among these, the metal contained in the blocking portion 2 is preferably Ni. Since Ni is excellent in corrosion resistance and oxidation resistance, Ni contributes to improvement in stability of the blocking portion 2.

The content of the metal in the blocking portion 2 is preferably 50 mass % or more, and more preferably 70 mass % or more. As a result, the gas shielding property and stability in the blocking portion 2 can be particularly enhanced.

The content of the metal in the blocking portion 2 is measured, for example, using an inductively coupled plasma optical emission spectrometer (ICP-OES) after the blocking portion 2 is taken out from the gas separation membrane 1.

Examples of method for forming the blocking portion 2 include a plating method, a liquid phase film forming method using a metal particle-containing liquid, and a vapor phase film forming method. Among these, the plating method is preferably used. That is, it is preferable that the blocking portion 2 is formed of a plating film. The plating film has high coverage and allows for easy control of the coating area. Therefore, by using the plating film, the blocking portion 2 having particularly good gas shielding property can be obtained.

When the blocking portion 2 is formed of the plating film, the blocking portion 2 may contain non-metals such as P (phosphorus), B (boron), S (sulfur), C (carbon), N (nitrogen), or O (oxygen) in addition to the above metals. This further enhances the stability of the plating film.

An average thickness of the blocking portion 2 is preferably 1 nm or more and 1000 nm or less, more preferably 5 nm or more and 500 nm or less, and still more preferably 10 nm or more and 300 nm or less. When the average thickness of the blocking portion 2 falls within the above range, it is possible to suppress the influence of the thickened blocking portion 2 on the adjacent separation layer 4 while improving the coverage and the gas shielding property of the defective portion 8 for the blocking portion 2. When the average thickness of the blocking portion 2 is less than the lower limit value, the blocking property and the gas shielding property of the blocking portion 2 for the defective portion 8 may decrease. However, when the average thickness of the blocking portion 2 exceeds the upper limit value, the thickened blocking portion 2 may affect the adjacent separation layer 4.

The defective portion 8 refers to a portion where the separation layer 4 is interrupted and the upper surface 31 of the support layer 3 is exposed. The blocking portion 2 illustrated in FIG. 1 is provided so as to cover the upper surface 31 exposed in the defective portion 8.

Moreover, the blocking portion 2 may not only cover the upper surface 31 but also partially extends into the support layer 3.

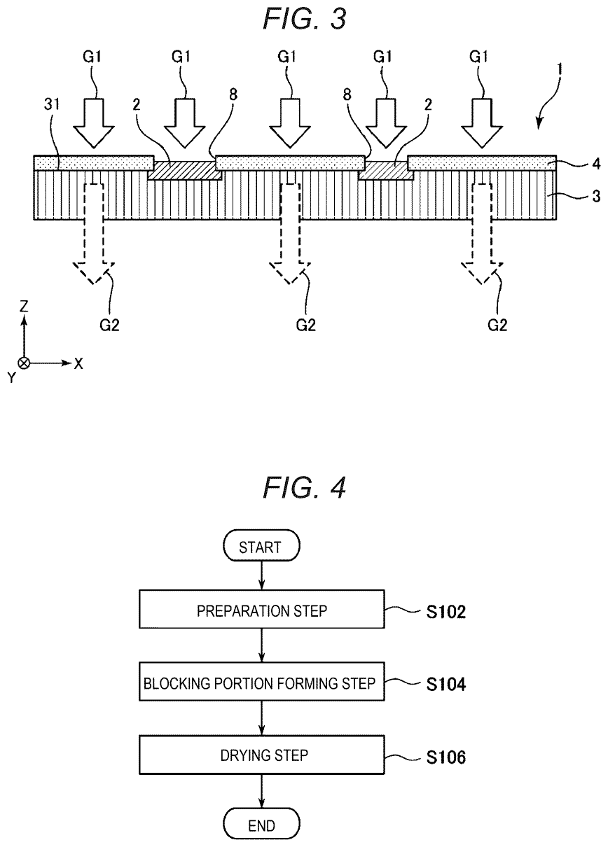

FIG. 3 is a cross-sectional view illustrating a gas separation membrane according to a modification in which a part of a blocking portion 2 extends into the inside of a support layer 3.

A part of the blocking portion 2 illustrated in FIG. 3 penetrates into the support layer 3. Specifically, since the support layer 3 includes pores, the blocking portion 2 extends into the pores. This makes it possible not only to cover the upper surfaces of the pores but also to fill the pores themselves. As a result, the defective portion 8 can be more reliably blocked.

The pores in the support layer 3 may extend in a certain direction or may extend in various directions. In the latter case, the blocking portion 2 that has extended into the pores may penetrate not only directly below the defective portion 8 but also to spread to the periphery as illustrated in FIG. 3. In this case, the blocking portion 2 and the separation layer 4 overlap each other at the boundary between the separation layer 4 and the defective portion 8. As a result, a gap is less likely to occur at the boundary between the blocking portion 2 and the separation layer 4, and the coverage of the blocking portion 2 can be further enhanced.

The penetration depth of the blocking portion 2, that is, the distance from the upper surface 31 of the support layer 3 to the lowermost end of the blocking portion 2 varies depending on the thickness of the support layer 3, and thus is not particularly limited, but is preferably 1 nm or more, more preferably 3 nm or more and 200 nm or less, and still more preferably 5 nm or more and 100 nm or less. Accordingly, the coverage of the blocking portion 2 can be particularly improved.

### 1.4. Other Configuration

Although the gas separation membrane 1 according to the embodiment is described above, any layer may be provided downstream of the support layer 3. For example, a porous plate having higher rigidity than the support layer 3 may be provided downstream of the support layer 3. The porous plate is formed with a large number of through holes so that the pressure loss of the gas passing therethrough is smaller than that of the support layer 3. Accordingly, the gas separation membrane 1 can be supported without inhibiting the gas selection ability in the gas separation membrane 1.

Examples of the constituent material of the porous plate include a ceramic material, a metal material and a polymer material. The constituent material of the porous plate may be a composite material of these materials and other materials.

### 2. Method for Manufacturing Gas Separation Membrane

Next, a method for manufacturing a gas separation membrane according to the embodiment will be described. In the following description, a method for manufacturing the gas separation membrane 1 illustrated in FIG. 1 will be described as an example.

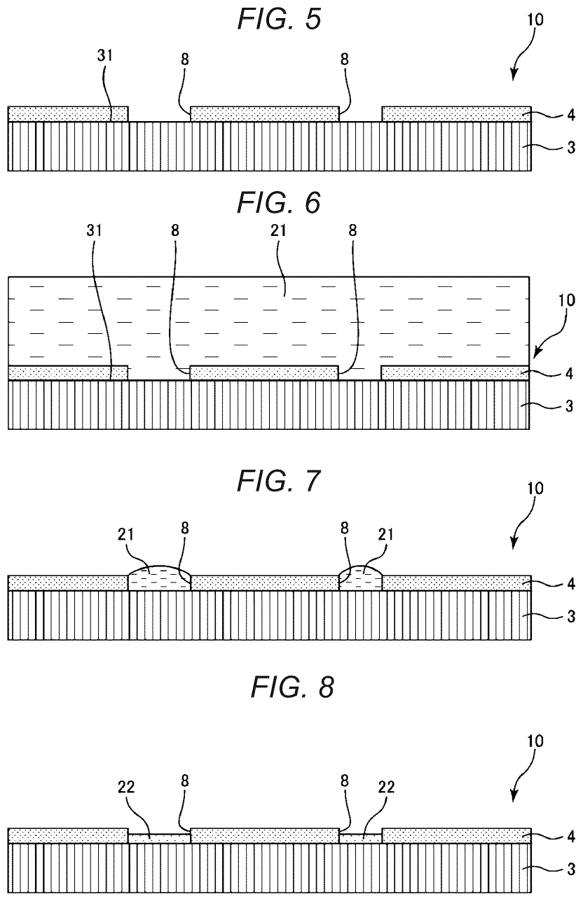

FIG. 4 is a process diagram illustrating a configuration of the method for manufacturing a gas separation membrane according to the embodiment. FIGS. 5 to 11 are schematic views illustrating the method for manufacturing the gas separation membrane illustrated in FIG. 4.

The method for manufacturing the gas separation membrane illustrated in FIG. 4 includes a preparation step S102, a blocking portion forming step S104, and a drying step S106. According to such a manufacturing method, the gas separation membrane 1 can be efficiently manufactured. The steps will each be described below.

### 2.1. Preparation Step

In the preparation step S102, a multilayer film 10 illustrated in FIG. 5 is prepared. The multilayer film 10 includes the support layer 3 formed of the porous body and the separation layer 4 in which the defective portion 8 is generated. Such a multilayer film 10 may be, for example, a gas separation membrane determined to be defective in the inspection of the gas selectivity ratio.

Examples of method for forming the separation layer 4 on the support layer 3 include a method in which a raw material liquid is applied, energy is then applied, and unnecessary substances are removed as necessary.

The raw material liquid contains a constituent material of the separation layer 4, a solvent, and the like. The raw material liquid is applied to the upper surface 31 of the support layer 3 by various coating methods. Examples of the coating method include a dipping method, a dripping method, an inkjet method, a dispenser method, a spraying method, a screen printing method, a coater coating method, and a spin coating method. Before the raw material liquid is supplied, the support layer 3 may be subjected to a pretreatment. Examples of the pretreatment include a plasma treatment, an ultraviolet ray irradiation treatment, and an ozone treatment.

Next, energy is applied to the obtained coating film. Examples of method for applying energy include a method of irradiating with energy rays such as infrared rays, visible light, and ultraviolet rays, a method of irradiating with plasma, and a method of irradiating with an electron beam. Accordingly, the coating film is cured or solidified, and the separation layer 4 is obtained.

### 2.2. Blocking Portion Forming Step

In the blocking portion forming step S104, the blocking portion 2 is selectively formed in the defective portion 8 by a plating method.

Examples of the plating method include an electroless plating method and an electrolytic plating method. Hereinafter, these will be sequentially described.

### 2.2.1. Electroless Plating Method

FIGS. 6 to 10 illustrate a process for forming the blocking portion 2 using the electroless plating method.

In the electroless plating method, first, as illustrated in FIG. 6, a catalyst solution 21 containing a catalyst is brought into contact with the separation layer 4 of the multilayer film 10. The method for contacting the catalyst solution 21 is not particularly limited, and examples thereof include a spin coating method, a dip coating method, and a spray coating method.

When the catalyst solution 21 is removed after the catalyst solution 21 is brought into contact with the separation layer 4, the catalyst solution 21 selectively attaches to the defective portion 8 as illustrated in FIG. 7. This is because the support layer 3 formed of the porous body is exposed in the defective portion 8. That is, it is considered that the surface roughness of the exposed surface of the porous body is relatively larger than that of the separation layer 4, and this increases the wettability of the catalyst solution 21. When the porous body is formed of an inorganic material, the wettability of the catalyst solution 21 may be further increased. Therefore, the catalyst solution 21 wets the upper surface 31 and penetrates into the pores provided in the support layer 3.

When the separation layer 4 is formed of an organic material, the liquid repellency to the catalyst solution 21 is higher than that of the support layer 3. Due to such a difference in wettability, the catalyst solution 21 selectively attaches to the defective portion 8.

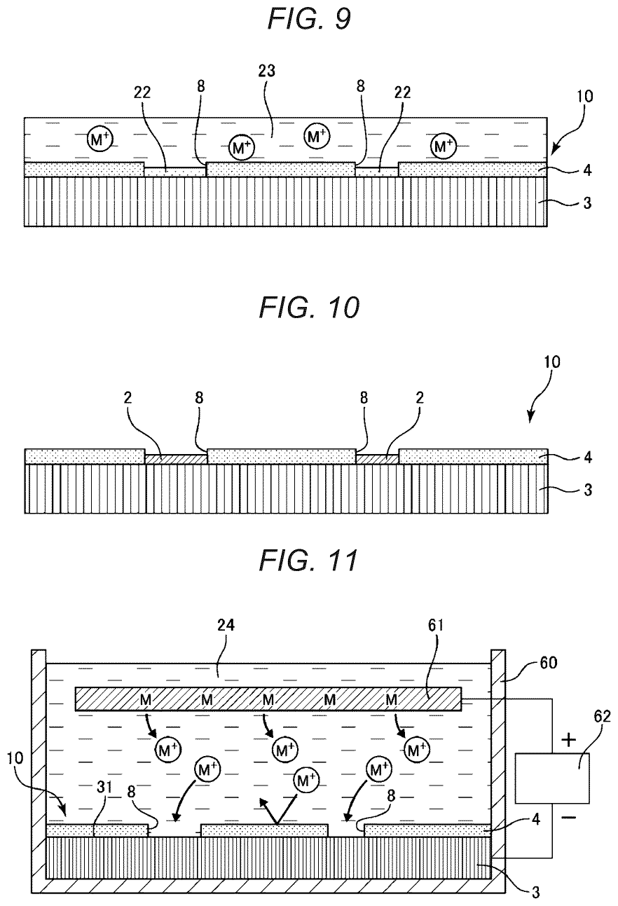

The catalyst contained in the catalyst solution 21 promotes the reducing agent function by oxidizing the reducing agent in an electroless plating solution 23 illustrated in FIG. 9 in the electroless plating method. Examples of such a catalyst include a Pd-Sn complex (palladium-tin complex).

Examples of the solvents contained in the catalyst solution 21 include water. The ratio of water in the catalyst solution 21 is preferably 80 mass % or more, and more preferably 90 mass % or more. Accordingly, in the catalyst solution 21, the properties of water become dominant, making it easier to control the wettability and the liquid repellency associated with each constituent material of the support layer 3 and the separation layer 4.

The catalyst solution 21 may be supplied to the defective portion 8 at once. In addition, as a result of sequentially supplying two or more kinds of liquids, the catalyst solution 21 which is a mixture thereof may be supplied to the defective portion 8. For example, the catalyst solution 21 containing both Pd and Sn may be attached to the defective portion 8 by sequentially bringing a solution containing Sn and a solution containing Pd into contact therewith.

After the contact with the catalyst solution 21, the catalyst is subjected to an activation treatment. As a result, the catalyst is activated, and as illustrated in FIG. 8, a catalyst layer 22 selectively adhered to the defective portion 8 is obtained. Examples of the activation treatment include a treatment in which, when the catalyst is a Pd-Sn complex, Sn is removed to leave catalytically active Pd. For such treatments, treatment liquids such as accelerators are used.

Next, as illustrated in FIG. 9, the catalyst layer 22 and the electroless plating solution 23 are brought into contact with each other. As a result, the reducing agent in the electroless plating solution 23 is oxidized, and the metal ions M⁺are reduced. Thus, metal is deposited around the catalyst in the catalyst layer 22. As a result, as illustrated in FIG. 10, the blocking portion 2 selectively covering the defective portion 8 is obtained.

### 2.2.2. Electrolytic Plating Method

In FIG. 11, a process of forming the blocking portion 2 using the electrolytic plating method is described.

In the electrolytic plating method, first, as illustrated in FIG. 11, the multilayer film 10 is disposed at the bottom of a plating tank 60. At this time, the lower surface of the support layer 3 is preferably covered so as not to be in contact with an electrolytic plating solution 24. An anode 61 is disposed at a position facing the separation layer 4 of the multilayer film 10. The negative electrode of a DC power supply 62 is electrically coupled to the support layer 3, and the positive electrode of the DC power supply 62 is electrically coupled to the anode 61. That is, the support layer 3 functions as a cathode in the electrolytic plating method. Therefore, a material having conductivity is preferably used as the constituent material of the support layer 3. Examples of the conductive material include a metal material, a conductive ceramic material, and a conductive silicon material. When the constituent material of the support layer 3 is a material having no conductivity, a porous conductive layer may be provided in advance between the support layer 3 and the separation layer 4.

Next, the electrolytic plating solution 24 is put into the plating tank 60, and the multilayer film 10 and the anode 61 are immersed in the electrolytic plating solution 24. Then, a voltage is applied (energized) between the support layer 3 and the anode 61 from the DC power supply 62. As a result, metal ions M⁺elute from the anode 61, and the eluted metal ions M⁺are reduced on the upper surface 31 of the support layer 3 exposed at the defective portion 8, depositing as metal. A portion of the upper surface 31 of the support layer 3 other than the defective portion 8 is covered with the separation layer 4. Therefore, the metal ions M⁺are not reduced, and the metal is not deposited. As a result, as illustrated in FIG. 10, the blocking portion 2 selectively covering the defective portion 8 is obtained. Therefore, the metal used for the blocking portion 2 may be used as the constituent material of the anode 61.

Also in the electrolytic plating method, when the support layer 3 is formed of an inorganic material, the electrolytic plating solution 24 not only wets the upper surface 31 but also penetrates into the pores provided in the support layer 3.

When the separation layer 4 is formed of an organic material, the liquid repellency of the electrolytic plating solution 24 is higher than that of the support layer 3. That is, penetration of the electrolytic plating solution 24 into the separation layer 4 is suppressed. Therefore, the precipitation of metal can be suppressed in the portion of the upper surface 31 of the support layer 3 covered with the separation layer 4.

Examples of the solvent contained in the electrolytic plating solution 24 include water. The ratio of water in the electrolytic plating solution 24 is preferably 80 mass % or more, and more preferably 90 mass % or more. Accordingly, in the electrolytic plating solution 24, the properties of water become dominant, making it easier to control the wettability and the liquid repellency associated with each constituent material of the support layer 3 and the separation layer 4.

### 2.3. Drying Step

In the drying step S106, first, the multilayer film 10 in which the blocking portion 2 has been formed is cleaned with a cleaning liquid such as water. Then, the multilayer film 10 is subjected to a drying treatment. Thus, the gas separation membrane 1 illustrated in FIG. 1 is obtained. The drying treatment may be natural drying or forced drying. Examples of the forced drying include heating, gas spraying, and vacuum drying.

As described above, by using the plating method, the blocking portion 2 that selectively blocks the defective portion 8 can be efficiently formed. Therefore, the method for manufacturing the gas separation membrane according to the embodiment can efficiently manufacture the gas separation membrane 1.

### 3. Use of Gas Separation Membrane

The gas separation membrane 1 according to the embodiment is used for separating and recovering the specific gas component from a mixed gas or for purification. Examples of the specific gas component include hydrogen, helium, carbon monoxide, carbon dioxide, hydrogen sulfide, oxygen, nitrogen, ammonia, sulfur oxide, nitrogen oxide, as well as saturated hydrocarbons such as methane and ethane, unsaturated hydrocarbons such as propylene, and perfluoro hydrocarbons such as tetrafluoroethane.

In particular, the gas separation membrane 1 is preferably used in a technique of separating and recovering carbon dioxide from mixed gas such as air or industrial exhaust gas.

### 4. Gas Separation Apparatus

Next, a gas separation apparatus according to the embodiment will be described.

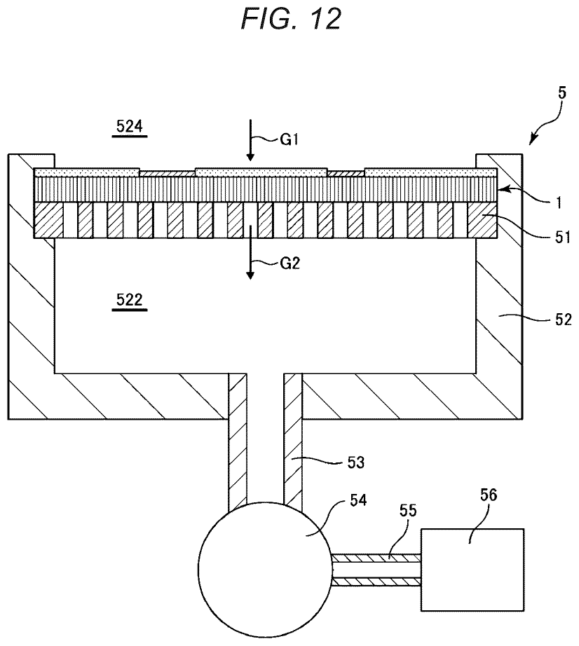

FIG. 12 is a cross-sectional view illustrating a schematic configuration of a gas separation apparatus 5 according to the embodiment.

The gas separation apparatus 5 illustrated in FIG. 12 includes the gas separation membrane 1, a fixing portion 52, a pipe 53, an exhaust unit 54, a pipe 55, and a gas concentration meter 56.

The fixing portion 52 fixes the gas separation membrane 1. The fixing portion 52 includes a porous plate 51 that supports the gas separation membrane 1. A large number of through holes are formed in the porous plate 51. The fixing portion 52 has an internal space 522 formed therein, which is located on the support layer 3 side of the gas separation membrane 1.

The exhaust unit 54 exhausts gas in the internal space 522 via the pipe 53. Accordingly, the pressure in the internal space 522 decreases, and the pressure becomes negative with respect to an external space 524 located on the separation layer 4 side of the gas separation membrane 1. As a result, the specific gas component from the mixed gas G1 supplied to the external space 524 permeates through the gas separation membrane 1 and is drawn into the internal space 522 as the permeate gas G2. Then, the permeate gas G2 is discharged from the internal space 522 along with the exhaust by the exhaust unit 54.

The permeate gas G2 discharged from the exhaust unit 54 is introduced into the gas concentration meter 56 through the pipe 55. Then, the concentration of the specific gas component in the permeate gas G2 is measured.

As described above, the gas separation membrane 1 has a high gas selectivity ratio and a high gas permeability for the specific gas component. Therefore, the gas separation apparatus 5 can efficiently separate the specific gas component while suppressing energy consumption.

The pipe 55 and the gas concentration meter 56 may be provided as necessary, and may be omitted.

### 5. Advantages Provided by Embodiment

The gas separation membrane 1 according to the above embodiment is a separation membrane that separates the specific gas component from the mixed gas containing a plurality of gas components by allowing the specific gas component to permeate therethrough, and includes the support layer 3, the separation layer 4, and the blocking portion 2. The support layer 3 includes a porous body having pores. The separation layer 4 is provided on the upper surface 31 (one surface) of the support layer 3 and has a gas separation ability of separating the specific gas component. The blocking portion 2 is provided corresponding to the defective portion 8 where the separation layer 4 has a defect and the support layer 3 is exposed, and contains metal.

According to such a configuration, since the defective portion 8 such as a pinhole is repaired by the blocking portion 2, the number of defective portions 8 is suppressed to be small, and the gas separation membrane 1 having a high gas selectivity ratio and a high gas permeability can be obtained. In addition, since the blocking portion 2 contains metal and has a high shielding rate against gas molecules even when it is thin, for example, even when there is a difference in thermal expansion coefficient between the blocking portion 2 and the support layer 3, the blocking portion 2 is less likely to peel off.

In the gas separation membrane 1 according to the embodiment, the constituent material of the porous body preferably contains an inorganic material.

According to such a configuration, since the inorganic material has high mechanical strength, the inorganic material contributes to thinning of the support layer 3 and to improvement in gas permeability of the support layer 3. Further, when the blocking portion 2 is formed by the plating method, the wettability of the catalyst solution 21 and the electrolytic plating solution 24 in the defective portion 8 can be further enhanced.

In the gas separation membrane 1 according to the embodiment, the constituent material of the separation layer 4 is preferably an organic material.

According to such a configuration, the separation layer 4 corresponding to various gas components can be realized according to the composition of the organic material. In addition, by using the organic material, it is possible to realize the separation layer 4 having excellent coverage of the support layer 3 even when the layer thickness is thin. Such a separation layer 4 contributes to realization of the gas separation membrane 1 having a high gas selectivity ratio and a high gas permeability.

In the gas separation membrane 1 according to the embodiment, it is preferable that the blocking portion 2 is the plating film.

According to such a configuration, since the plating film has high coverage and the coating range can be easily controlled, it is possible to realize the blocking portion 2 having particularly good gas shielding property.

In the gas separation membrane 1 according to the embodiment, the metal contained in the blocking portion 2 may be Ni.

According to such a configuration, since Ni is excellent in corrosion resistance and oxidation resistance, the stability of the blocking portion 2 is improved.

In the gas separation membrane 1 according to the embodiment, a part of the blocking portion 2 may extend into the pores of the porous body.

According to such a configuration, it is possible not only to cover the upper surface of the pores but also to fill the pores themselves. As a result, the blocking portion 2 that can more reliably block the defective portion 8 can be obtained.

The method for manufacturing a gas separation membrane according to the embodiment is a method for manufacturing the gas separation membrane 1 according to the embodiment and includes the preparation step S102, the blocking portion forming step S104, and the drying step S106.

In the preparation step S102, the multilayer film 10 includes the support layer 3 formed of the porous body and the separation layer 4 in which the defective portion 8 is generated is prepared. In the blocking portion forming step S104, the blocking portion 2 is selectively formed at the defective portion 8 by the plating method. In the drying step S106, the multilayer film 10 on which the blocking portion 2 is formed is dried to obtain the gas separation membrane 1.

According to such a configuration, since the blocking portion 2 that selectively blocks the defective portion 8 can be efficiently formed by using the plating method, the number of defective portions 8 is suppressed to be small, and the gas separation membrane 1 having a high gas selectivity ratio and a high gas permeability can be efficiently manufactured.

In the method for manufacturing a gas separation membrane according to the embodiment, the plating method may be the electroless plating method. In this case, the blocking portion forming step S104 includes a process of bringing the catalyst solution 21 containing a catalyst into contact with the defective portion 8 to selectively attach the catalyst to the defective portion 8, and a process of bringing the electroless plating solution 23 containing metal ions M⁺into contact with the catalyst attached to the defective portion 8 to deposit metal.

According to such a configuration, the blocking portion 2 can be efficiently formed by the electroless plating method.

In the method for manufacturing the gas separation membrane according to the embodiment, it is preferable that the separation layer 4 has higher liquid repellency to the catalyst solution 21 than the support layer 3.

According to such a configuration, since there is a difference in the wettability of the catalyst solution 21 between the support layer 3 and the separation layer 4, the catalyst solution 21 can be selectively attached to the defective portion 8 due to this difference in wettability.

In the method for manufacturing the gas separation membrane according to the embodiment, the plating method may be the electrolytic plating method. In this case, the porous body preferably has electrical conductivity. The blocking portion forming step S104 includes a process of energizing the porous body and a process of bringing the electrolytic plating solution 24 containing the metal ions M⁺into contact with the defective portion 8 to deposit the metal.

According to such a configuration, the blocking portion 2 can be efficiently formed by the electrolytic plating method.

In the method for manufacturing a gas separation membrane according to the embodiment, the separation layer 4 preferably has higher liquid repellency of the electrolytic plating solution 24 than the support layer 3.

According to such a configuration, since there is a difference in the wettability of the electrolytic plating solution 24 between the support layer 3 and the separation layer 4, the electrolytic plating solution 24 can be selectively attached to the defective portion 8 due to this difference in wettability.

The gas separation apparatus 5 according to the embodiment includes the gas separation membrane 1 according to the embodiment, the fixing portion 52, and the exhaust unit 54. The fixing portion 52 fixes the gas separation membrane 1. The fixing portion 52 has the internal space 522 formed at the support layer 3 side of the gas separation membrane 1. The exhaust unit 54 reduces the pressure in the internal space 522 so as to be negative with respect to the external space 524 on the separation layer 4 side of the gas separation membrane 1.

According to such a configuration, the gas separation apparatus 5 capable of efficiently separating the specific gas component while suppressing energy consumption is obtained.

The gas separation membrane, the method for manufacturing the gas separation membrane and the gas separation apparatus according to the present disclosure have been described above based on the preferred embodiment, but the present disclosure is not limited thereto.

For example, the gas separation membrane and the gas separation apparatus according to the present disclosure may be an apparatus in which each unit of the above-described embodiment is replaced with a constituent having substantially the same function, or may be an apparatus in which any constituents are added to the above-described embodiment.

The method for manufacturing the gas separation membrane according to the present disclosure may be one in which any desired process is added to the above embodiment.

### EXAMPLES

Then, specific examples of the present disclosure will be described.

### 6. Preparation and Evaluation of Gas Separation Membrane

### 6.1. Preparation of Gas Separation Membrane of Comparative Examples 1 to 4

First, four multilayer films in which a support layer and a separation layer were laminated were prepared. The presence of a defective portion in the separation layer was confirmed beforehand. These four multilayer films were used as the gas separation membranes of Comparative Examples 1 to 4.

An alumina porous body having an average thickness of 125 μm was used as the support layer. As the separation layer, a thin film of polydimethylsiloxane having an average thickness of 100 nm formed at the upper surface of the support layer by a liquid phase deposition method and plasma irradiation was used.

6.2. Evaluation Method of Gas Separation Membranes of Comparative Examples 1 to 4

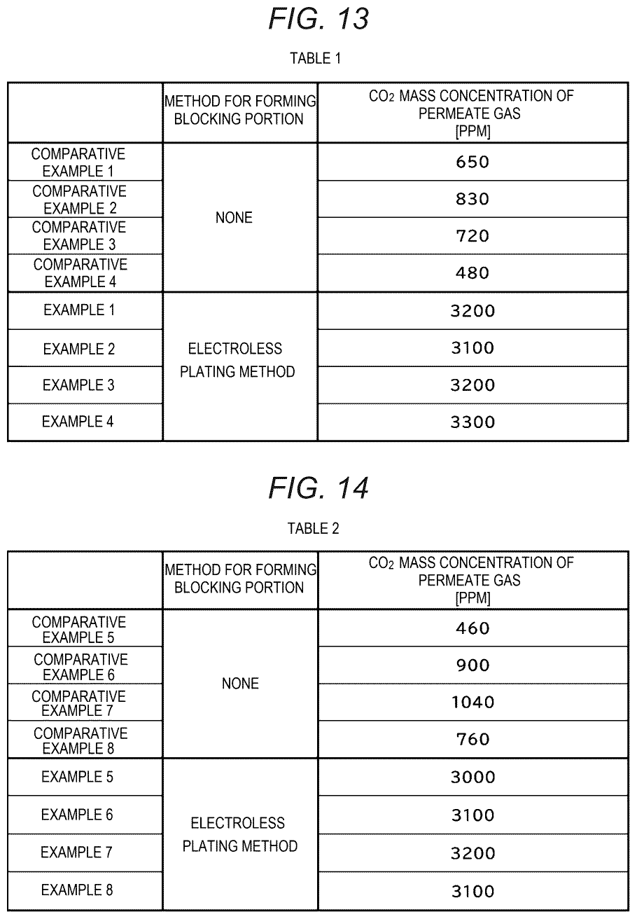

Next, the gas separation membranes of Comparative Examples 1 to 4 were set in the gas separation apparatus illustrated in FIG. 12. Then, air containing CO₂ at a mass concentration of 400 ppm was used as a mixed gas, and the mass concentration of CO₂ in the permeate gas was measured. The measurement results are shown in Table 1 (FIG. 13). FIG. 13 is Table 1 showing configurations and evaluation results of gas separation membranes of Comparative Examples 1 to 4 and gas separation membranes of Examples 1 to 4.

### 6.3. Preparation of Gas Separation Membranes of Examples 1 to 4

For the gas separation membranes of Comparative Examples 1 to 4 evaluated as described above, the defective portion was repaired by an electroless plating method as follows.

First, a catalyst solution was supplied so as to be in contact with the separation layers of the gas separation membranes of Comparative Examples 1 to 4. A Pd-Sn complex was used as the catalyst. Subsequently, the catalyst was subjected to an activation treatment to form a catalyst layer selectively covering the defective portion.

Next, the catalyst layer was brought into contact with an electroless plating solution for Ni plating, and a blocking portion that selectively covers the defective portion was formed by the electroless plating method. Thereafter, the multilayer film in which the blocking portion was formed was washed and dried. As a result, the gas separation membranes of Examples 1 to 4 in which the defective portion was repaired with the blocking portion was obtained. The average thickness of the blocking portions was 80 nm.

### 6.4. Evaluation Method of Gas Separation Membranes of Examples 1 to 4

Next, the gas separation membranes of Examples 1 to 4 were set in the gas separation apparatus illustrated in FIG. 12. Then, air containing CO₂ at a mass concentration of 400 ppm was used as a mixed gas, and the mass concentration of CO₂ in the permeate gas was measured. The measurement results are shown in Table 1 (FIG. 13).

### 6.5. Evaluation Results of Gas Separation Membranes of Comparative Examples 1 to 4 and Examples 1 to 4

As shown in Table 1, in the gas separation membranes of Comparative Examples 1 to 4, the CO₂ mass concentration of the permeate gas was slightly higher than that of the mixed gas, but the increase width was slight. In addition, since the variation in the CO₂ mass concentration of the permeate gas is large, it is presumed that the defective portion is insufficiently repaired and the mixed gas permeates as it is.

However, in the gas separation membranes of Examples 1 to 4, it was confirmed that the CO₂ mass concentration of the permeate gas was sufficiently higher than that of the mixed gas. These results indicate that the gas separation membranes of Examples 1 to 4 exhibited both a high CO₂ gas selectivity ratio and a high gas permeability. In addition, since the variation in the CO₂ mass concentration of the permeate gas is small, it is presumed that the defective portion is reliably repaired.

When the gas separation membranes of Examples 1 to 4 were cut in the thickness direction and the cut surfaces were observed with an electron microscope, it was confirmed that a part of the blocking portion penetrated into the support layer.

### 6.6. Preparation of Gas Separation Membranes of Comparative Example 5 to 8

First, four multilayer films in which a support layer and a separation layer were laminated were prepared. The presence of a defective portion in the separation layer was confirmed beforehand. These four multilayer films were used as the gas separation membranes of Comparative Examples 5 to 8.

A porous stainless steel body having an average thickness of 300 μm was used as the support layer. As the separation layer, a thin film of polydimethylsiloxane having an average thickness of 100 nm formed at the upper surface of the support layer by a liquid phase deposition method and plasma irradiation was used.

### 6.7. Evaluation Method of Gas Separation Membranes of Comparative Examples 5 to 8

Next, the gas separation membranes of Comparative Examples 5 to 8 were set in the gas separation apparatus illustrated in FIG. 12. Then, air containing CO₂ at a mass concentration of 400 ppm was used as a mixed gas, and the mass concentration of CO₂ in the permeate gas was measured. The measurement results are shown in Table 2 (FIG. 14). FIG. 14 is Table 2 showing configurations and evaluation results of gas separation membranes of Comparative Examples 5 to 8 and gas separation membranes of Examples 5 to 8.

### 6.8. Preparation of Gas Separation Membranes of Examples 5 to 8

For the gas separation membranes of Comparative Examples 5 to 8 evaluated as described above, the defective portion was repaired by an electrolytic plating method as follows.

First, the gas separation membranes of Comparative Examples 5 to 8 were placed in a plating tank and immersed in an electrolytic plating solution together with a Ni anode. Then, a voltage was applied between the support layer and the anode to form a blocking portion selectively covering the defective portion by the electrolytic plating method. Thereafter, the multilayer film in which the blocking portion was formed was washed and dried. As a result, gas separation membranes of Examples 5 to 8 in which the defective portion was repaired with the blocking portion were obtained. The average thickness of the blocking portions was 120 nm.

### 6.9. Evaluation Method of Gas Separation Membranes of Examples 5 to 8

Next, the gas separation membranes of Examples 5 to 8 were set in the gas separation apparatus illustrated in FIG. 12. Then, air containing CO₂ at a mass concentration of 400 ppm was used as a mixed gas, and the mass concentration of CO₂ in the permeate gas was measured. The measurement results are shown in Table 2 (FIG. 14).

### 6.10. Evaluation Results of Gas Separation Membranes of Comparative Examples 5 to 8 and Examples 5 to 8

As shown in Table 2, in the gas separation membranes of Comparative Examples 5 to 8, the CO₂ mass concentration of the permeate gas was slightly higher than that of the mixed gas, but the increase width was slight. In addition, since the variation in the CO₂ mass concentration of the permeate gas is large, it is presumed that the defective portion is insufficiently repaired and the mixed gas permeates as it is.

However, in the gas separation membranes of Examples 5 to 8, it was confirmed that the CO₂ mass concentration of the permeate gas was sufficiently higher than that of the mixed gas. These results indicate that the gas separation membranes of Examples 5 to 8 exhibited both a high CO₂ gas selectivity ratio and a high gas permeability. In addition, since the variation in the CO₂ mass concentration of the permeate gas is small, it is presumed that the defective portion is reliably repaired.

When the gas separation membranes of Examples 5 to 8 were cut in the thickness direction and the cut surfaces were observed with an electron microscope, it was confirmed that a part of the blocking portion penetrated into the support layer.

As is clear from the above evaluation results, it was confirmed that the gas separation membrane of each example has a small number of defective portions of the separation layer and has a high gas selectivity ratio and a high gas permeability for a specific gas component.

What is claimed is:

1. A gas separation membrane separates a specific gas component from a mixed gas having a plurality of gas components by allowing the specific gas component to permeate therethrough, the gas separation membrane comprising:
a support layer formed of a porous body having pores;
a separation layer provided on one surface of the support layer and having a gas separation ability for the specific gas component; and
a blocking portion provided corresponding to a defective portion where the separation layer has a defect and the support layer is exposed, and containing metal.

2. The gas separation membrane according to claim 1, wherein a constituent material of the porous body contains an inorganic material.

3. The gas separation membrane according to claim 1, wherein a constituent material of the separation layer is an organic material.

4. The gas separation membrane according to claim 1, wherein the blocking portion is a plating film.

5. The gas separation membrane according to claim 1, wherein the metal contained in the blocking portion is Ni.

6. The gas separation membrane according to claim 1, wherein a part of the blocking portion extends into the pores of the porous body.

7. A method for manufacturing the gas separation membrane according to claim 1, the method comprising:
preparing a multilayer film including the support layer formed of the porous body and the separation layer in which the defective portion is generated;
forming the blocking portion by a plating method, the blocking portion being selectively formed in the defective portion; and
drying the multilayer film in which the blocking portion is formed to obtain the gas separation membrane.

8. The method for manufacturing the gas separation membrane according to claim 7, wherein the plating method is an electroless plating method, and the blocking portion forming step comprises:
bringing a catalyst solution containing a catalyst into contact with the defective portion to selectively attach the catalyst to the defective portion, and
bringing an electroless plating solution containing metal ions into contact with the catalyst attached to the defective portion to deposit the metal.

9. The method for manufacturing the gas separation membrane according to claim 8, wherein the separation layer has higher liquid repellency of the catalyst solution than the support layer.

10. The method for manufacturing the gas separation membrane according to claim 7, wherein the plating method is an electrolytic plating method, the porous body has conductivity, and the blocking portion forming step comprises:
energizing the porous body; and
bringing an electrolytic plating solution containing metal ions into contact with the defective portion to deposit the metal.

11. The method for manufacturing the gas separation membrane according to claim 10, wherein the separation layer has higher liquid repellency of the electrolytic plating solution than the support layer.

12. A gas separation apparatus comprising:
the gas separation membrane according to claim 1;
a fixing portion that fixes the gas separation membrane and in which an internal space is formed at the support layer side of the gas separation membrane; and
an exhaust unit that reduces a pressure in the internal space so as to be negative with respect to an external space on the separation layer side of the gas separation membrane.
